(19) United States
(12) Patent Application Publication
(10) Pub. No.: US 2015/0205374 A1
(43) Pub. Date: Jul. 23, 2015

(54) INFORMATION PROCESSING METHOD AND ELECTRONIC DEVICE

(71) Applicants: Beijing Lenovo Software Ltd., Beijing (CN); Lenovo (Beijing) Limited, Beijing (CN)

(72) Inventors: Juanjuan Yao, Beijing (CN); Chunhui Sun, Beijing (CN); Weizhi Lin, Beijing (CN); Jiangping Wu, Beijing (CN); Rong Zhang, Beijing (CN); Xuegong Zhou, Beijing (CN); Bin Shi, Beijing (CN); Jianwei Li, Beijing (CN)

(21) Appl. No.: 14/468,105

(22) Filed: Aug. 25, 2014

(30) Foreign Application Priority Data
Jan. 20, 2014 (CN) 201410025791.3
Jan. 20, 2014 (CN) 201410025792.8
Jan. 20, 2014 (CN) 201410025979.8

(51) Int. Cl. G06F 3/038; G06F 3/03; G06F 3/01

(52) U.S. Cl. CPC G06F 3/038; G06F 3/017; G06F 3/0304

(57) ABSTRACT

The present invention discloses an information processing method for solving a problem in the prior art that operations are complicated when control modes of an electronic device is adjusted. The method comprises: detecting the number of operating bodies in a sensing space by using a sensing unit to obtain a first detection result; detecting whether the operating bodies are located on the first plane by using the sensing unit to obtain a second detection result; controlling the electronic device to work in a first working mode when the first detection result meets a first preset condition and/or the second detection result meets a second preset condition. The present invention further discloses a corresponding electronic device. Additionally, the present invention further discloses a method and corresponding electronic device for addressing a problem in the prior art that the error rate of responses from an electronic device is high when a user is operating a virtual keyboard. Additionally, the present invention further discloses a method and corresponding electronic device for addressing a problem in the prior art that the error rate of responses from an electronic device increases as the projecting direction cannot be adaptively adjusted when the electronic device is projecting.

### CROSS-REFERENCE TO RELATED APPLICATION(S)

This application claims priority to Chinese Application No. 201410025792.8, entitled “Information Processing Method and Electronic Device”, filed on Jan. 20, 2014, Chinese Application No. 201410025979.8, entitled “Information Processing Method and Electronic Device”, filed on Jan. 20, 2014, and Chinese Application No. 201410025791.3, entitled “Information Processing Method and Electronic Device”, filed on Jan. 20, 2014, all of which are incorporated herein by reference in their entirety.

### TECHNICAL FIELD

The present invention relates to the field of computer technology, and in particular, to information processing methods and electronic devices.

### BACKGROUND

With development of science and technology, electronic devices are rapidly developing. There are more types of electronic products, and people enjoy convenience brought by the development of science and technology. Nowadays, by using various types of electronic devices, people can enjoy comfortable lives brought by the science and technology development. For instance, electronic devices, such as mobile phones, have already become indispensable to people's lives. People can enhance connections to others by making phone calls or texting using electronic devices, such as mobile phones.

Conventionally, due to different information input methods, electronic devices may be controlled in various manners. For example, it may be controlled in a mouse-control manner and a voice-control manner. An advanced electronic device may further support a gesture-control manner. The conventional control manner for adjusting electronic devices is manual operations by users and the electronic device cannot be adjusted adaptively. This increases the complexity of the operations, decreases the intelligence of the electronic devices, and brings inconvenience to the users.

Further, in the prior art, the projecting units of some electronic devices, e.g. PCs (personal computers), etc., may project virtual keyboards. When users are operating the virtual keyboards, cameras of the electronic devices are used to capture images of user's operations and the electronic devices respond according to the images captured by the cameras. However, the resolution of a camera on a typical electronic device is limited and its captured images may not be clear. The responses to the user operations based on the analysis of the images captured by the cameras may not be accurate enough. Because the captured images are not accurate enough, the electronic devices may obtain inaccurate information, and thus generate error responses. Usually, the electronic devices project virtual keyboard on the desktop. In addition, a virtual keyboard is typically projected onto the surface of a desk. During the user's operation, some of the keys may be blocked by the user's hands. This leads to inaccurate captured images and sometimes the electronic device may not recognize which key is pressed by the user. As a result, an error response or no response comes up, error responses of the electronic devices increase, and user experience is impacted.

Furthermore, in the prior art, in a formal occasion, a dedicated projector will be used when projection is needed. However, users may usually want to project at any time. For convenience, many electronic devices are equipped with projecting units. For example, an electronic device projects content to an area and user A may view the projected content. When User A invites User B, who is standing beside the user A, to view the display screen, user A may then turn the display screen to user B. If a projecting unit is located on the display screen, the direction of the display unit will be changed accordingly and the electronic device will project the content to a new area during the projection. It is inconvenient if user A wants to continue using the projected content and this may cause error operations. It can be seen that conventional electronic devices cannot adaptively adjust the projecting direction when projecting. This may increase the error rate of operations from the user, raise the error rate of responses from the responding electronic device, and bring greater inconvenience to the users.

### SUMMARY

Information processing methods and electronic devices are provided in some embodiments of the present invention for solving the technical problem in the prior art that the operation is complex when adjusting the control mode of electronic devices.

According to the first aspect of the present disclosure, an information processing method in an electronic device is provided. The electronic device comprises a sensing unit configured to detect posture change of operating bodies in a sensing space which comprises a first plane. The electronic device has multiple working modes comprising a first working mode. The method comprises:

detecting the number of the operating bodies in the sensing space by a sensing unit to obtain a first detection result;

detecting whether the operating bodies are located on the first plane by the sensing unit to obtain a second detection result; and

controlling the electronic device to work in the first working mode when the first detection result meets a first preset condition and/or the second detection result meets a second preset condition.

Preferably, the controlling of the electronic device to work in the first working mode when the first detection result meets a first preset condition and/or the second detection result meets a second preset condition comprises:

when the first detection result indicates that the number of the operating bodies is greater than or equal to 1, determining the first detection result meets the first preset condition;

when the second detection result indicates that none of the operating bodies is located on the first plane, determining the second detection result meets the second preset condition;

controlling the electronic device to work in the space-gesture control mode.

Preferably, the controlling of the electronic device to work in the space-gesture control mode comprises: controlling the electronic device to turn-on the space-gesture detection unit therein.

Preferably, controlling the electronic device to work in the first working mode when the first detection result meets a first preset condition and/or the second detection result meets a second preset condition comprises:

when the first detection result indicates that the number of the operating bodies is equal to 1, determining the first detection result meets the first preset condition;

when the second detection result indicates that the operating body is located on the first plane, determining the second detection result meets the second preset condition; and

controlling the electronic device to work in a gesture-simulate-mouse control mode.

Preferably, the controlling of the electronic device to work in a gesture-simulate-mouse control mode comprises: controlling the electronic device to turn-on the gesture-simulate-mouse detection unit therein.

Preferably, the controlling of the electronic device to work in the first working mode when the first detection result meets a first preset condition and/or the second detection result meets a second preset condition comprises:

when the first detection result indicates that the number of the operating bodies is greater than or equal to 2, determining the first detection result meets the first preset condition;
when the second detection result indicates that all the operating bodies are located on the first plane, determining the second detection result meets the second preset condition;

controlling the electronic device to work in a gesture-simulate-keyboard control mode.

Preferably, the controlling of the electronic device to work in a gesture-simulate-keyboard control mode comprises: controlling the electronic device to turn-on the gesture-simulate-keyboard control unit therein.

Preferably, the electronic device further comprises a projecting unit. After the controlling of the electronic device to work in the first working mode, the method further comprises: controlling the projecting unit to project a virtual input interface corresponding to the first working mode, for the user to perform input operations via the virtual input interface.

Preferably, the controlling of the projecting unit to project a virtual input interface corresponding to the first working mode comprises:

determining the depth-of-field of the operating bodies by the sensing unit;

determining the projecting area based on the determined depth-of-field; and

controlling the projecting unit to project the virtual input interface into the projecting area.

According to the second aspect of the present disclosure, an electronic device is provided. The electronic device comprises a sensing unit configured to detect posture change of operating bodies in the sensing space which comprises a first plane. The electronic device has multiple working modes comprising a first working mode. The electronic device further comprises:

a first detecting unit configured to detect the number of the operating bodies in the sensing space by using the sensing unit, to obtain a first detection result;

a second detecting unit configured to detect whether the operating bodies are located on the first plane by using the sensing unit, to obtain a second detection result; and

a control unit configured to, when the first detection result meets a first preset condition and/or the second detection result meets a second preset condition, control the electronic device to work in the first working mode.

Preferably, the control unit is specifically configured to: when the first detection result indicates that the number of the operating bodies is greater than or equal to 1, determine the first detection result meets the first preset condition; when the second detection result indicates that none of the operating bodies is located on the first plane, determine the second detection result meets the second preset condition; control the electronic device to work in the space-gesture control mode.

Preferably, the control unit is specifically configured to: control the electronic device to turn-on the space-gesture detection unit therein.

Preferably, the control unit is specifically configured to: when the first detection result indicates that the number of the operating bodies is equal to 1, determine the first detection result meets the first preset condition; when the second detection result indicates that the operating bodies are located on the first plane, determine the second detection result meets the second preset condition; control the electronic device to work in the gesture-simulate-mouse control mode.

Preferably, the control unit is configured to: control the electronic device to turn-on the gesture-simulate-mouse detection unit therein.

Preferably, the control unit is specifically configured to: when the first detection result indicates that the number of the operating bodies is greater than or equal to 2, determine the first detection result meets the first preset condition; when the second detection result indicates that the operating bodies are all located on the first plane, determine the second detection result meets the second preset condition; control the electronic device to work in the gesture-simulate-keyboard control mode.

Preferably, the control unit is specifically configured to: control the electronic device to turn-on the gesture-simulate-keyboard control unit therein.

Preferably, the electronic device further comprises projecting unit. The control unit is further configured to: control the projecting unit to project a virtual input interface corresponding to the first working mode, for the user to perform input operations via the virtual input interface.

Preferably, the control unit is further configured to: determine the depth-of-field of the operating bodies by the sensing unit; determine the projecting area based on the determined depth-of-field; control the projecting unit to project the virtual input interface into the projecting area.

In the embodiments of the present invention according to the first and second aspects, the first detection result and the second detection result are obtained by using the sensing unit; when the first detection result meets a first preset condition and/or the second detection result meets a second preset condition, the electronic device is controlled to work in the first working mode. That is, the electronic device may autonomously adjust the control manners of the electronic device based on the detected result, such that the control manners of the electronic device complies with the user's current condition and no manual adjustment is required. The adaptive adjustment of the electronic device simplifies the operation process, improves the intelligence thereof, and brings the convenience to the users.

Additionally, information processing methods and electronic devices are further provided by some embodiments of the present invention for addressing a technical problem in the prior art that the error rate of responses is high when the user is operating a virtual keyboard.

According to the third aspect of the present disclosure, an information processing method in an electronic device comprising a sensing unit and a projecting unit is provided. The sensing unit can detect posture change of operating bodies in the sensing space, which comprises a first plane, to perform an input operation. The projecting unit is configured to project an input interface. The method comprises following steps:

detecting the position of the first plane by the sensing unit;

determining the sensing area on the first plane based on the position of the first plane, the input of the operating bodies in the sensing area being able to be captured by the sensing unit;

controlling the projecting parameters of the projecting unit based on the determined sensing area, and projecting the input interface on the sensing area to make the input interface and the sensing area overlap each other.

Preferably, the input interface is the interface corresponding to the input device.

Preferably, the input interface is a keyboard input interface and the input device is a keyboard; or the input interface is a mouse input interface and the input device is a mouse; or the input interface is a writing pad input interface and the input device is a writing pad; or the input interface is a touch pad input interface and the input device is a touch pad.

Preferably, the determining of the sensing area on the first plane based on the position of the first plane comprises: capturing an image including gesture information of the user by the sensing unit; when it is determined that the gesture information comprises at least one hand of the user and the first plane below the at least one hand and that the distance between the at least one hand and the first plane is less than a preset distance, determining the sensing area on the first plane by the sensing unit.

Preferably, the determining of the sensing area on the first plane by the sensing unit comprises: determining the location of the at least one hand of the user as the sensing area by the sensing unit.

Preferably, after the controlling of the projecting parameters of the projecting unit based on the determined sensing area and the projecting of the input interface on the sensing area, the method further comprises:

obtaining operation information with respect to the input interface by the sensing unit;

responding to the operation information by the sensing unit and determining the corresponding position of the operation information on the input interface; and

performing operations corresponding to the determined position.

Preferably, when the input interface is a keyboard input interface, the responding to the operation information by the sensing unit and the determining of the corresponding position of the operation information on the input interface comprises: responding to the operation information by the sensing unit and determining the corresponding position of the operation information on the input interface; determining the virtual key corresponding to the location; the performing of operations corresponding to the determined position comprises: performing operations corresponding to the virtual key.

According to the fourth aspect of the present disclosure, an electronic device comprising a sensing unit and a projecting unit is provided. The sensing unit can detect posture change of operating bodies in the sensing space, which comprises a first plane, to perform an input operation. The projecting unit is configured to project an input interface. The electronic device comprises:

a detection unit, configured to detect the position of the first plane by the sensing unit;

a determination unit configured to determine the sensing area on the first plane based on the position of the first plane, the input of the operating bodies in the sensing area being able to be captured by the sensing unit;

a control unit configured to control the projecting parameters of the projecting unit based on the determined sensing area, and to project the input interface on the sensing area to make the input interface and the sensing area overlap each other.

Preferably, the input interface is the interface corresponding to the input device.

Preferably, the input interface is a keyboard input interface and the input device is a keyboard; or the input interface is a mouse input interface and the input device is a mouse; or the input interface is a writing pad input interface and the input device is a writing pad; or the input interface is a touchpad input interface and the input device is a touchpad.

Preferably, determination unit is specifically configured to: capture an image including a gesture information of the user by the sensing unit; when it is determined that the gesture information comprises at least one hand of the user and the first plane below the at least one hand, and that the distance between the at least one hand and the first plane is less than a preset distance, determine the sensing area on the first plane by the sensing unit.

Preferably, the determination unit configured to determine the sensing area on the first plane by the sensing unit specifically comprises: determine the location of the at least one hand of the user as the sensing area by the sensing unit.

Preferably, the electronic device further comprises an obtaining unit, a responding unit, and an execution unit;

the obtaining unit is configured to obtain operation information with respect to the input interface by the sensing unit;

the responding unit is configured to respond to the operation information by the sensing unit and determine the corresponding position of the operation information on the input interface;

the execution unit is configured to perform operations corresponding to the determined position.

Preferably, the responding unit configured to respond to the operation information by the sensing unit and determine the corresponding position of the operation information on the input interface is specifically configured to: when the input interface is a keyboard input interface, respond to the operation information by the sensing unit and determine the corresponding position of the operation information on the input interface; determine the virtual key corresponding to the location; the execution unit is specifically configured to: perform operations corresponding to the virtual key.

In the embodiments of the present invention according to the third and fourth aspects, the sensing area is determined by the sensing unit, and the projecting unit is controlled to project the input interface on the sensing area to make the input interface and the sensing area overlap each other. The operating bodies operate on the input interface, that is, on the sensing area. The sensing unit may directly respond to operations of the operating bodies. The sensing unit may be, for example, Leap Motion, which can accurately capture the operation of the operating bodies, and then both the capturing and responding are relatively more accurate, compared with the conventional solution where the user's operation is captured by a camera and then responded accordingly. This may prevent the error responses to the user's operation from happening as much as possible, reduce the error rate of responses, and improve the user experience.

Furthermore, information processing methods and electronic devices are provided by some embodiments of the present invention for addressing a problem in the prior art that since the projecting direction cannot be adaptively adjusted when the electronic device is projecting, the error rate of responses from the electronic device increases.

According to the fifth aspect of the present disclosure, an information processing method in an electronic device comprising a projecting unit and a sensing unit is provided. The method comprises:

obtaining a trigger operation information when an input interface is projected to a fixed area in a first direction by the projecting unit, the trigger operation information triggering a change of the direction of the projecting unit from the first direction to the second direction;

determining whether a current scenario information of the electronic device meets a preset condition by using the sensing unit; and

controlling the projecting unit to keep on the first direction and continue projecting the input interface to the fixed area when the current scenario information meets the preset condition.

Preferably, the determining of whether current scenario information of the electronic device meets a preset condition by using the sensing unit comprises:

obtaining a current scenario image corresponding to the current scenario information by the sensing unit; and

determining whether there are M faces in the first direction and N faces in the second direction based on the current scenario image, M being a positive integer and N being an integer greater than or equal to 0;

wherein it is determined that the current scenario information meets the preset condition if there are M faces in the first direction and N faces in the second direction.

Preferably, the determining of whether current scenario information of the electronic device meets a preset condition by using the sensing unit comprises:

obtaining a current scenario image corresponding to the current scenario information by the sensing unit;

determining whether a specific face is in the first direction based on the current scenario image; and

determining that the current scenario information meets the preset condition when the specific face is in the first direction.

Preferably, the determining of whether current scenario information of the electronic device meets a preset condition by the sensing unit comprises:

obtaining the current scenario sound corresponding to the current scenario information by the sensing unit;

determining whether there is sound information in the first direction;

wherein it is determined that the current scenario information meets the preset condition when there is sound information in the first direction.

Preferably, determining whether current scenario information of the electronic device meets a preset condition by using the sensing unit comprises:

obtaining the current scenario sound corresponding to the current scenario information by the sensing unit;

determining whether there is specific sound information in the first direction;

wherein, determining the current scenario information meets the preset condition when there is specific sound information in the first direction.

Preferably, after determining whether the current scenario information of the electronic device meets a preset condition, the method further comprises: controlling the projecting unit to project the input device interface to an update area along the second direction when the current scenario information does not meet the preset condition; the update area being different from the fixed area.

Preferably, after controlling the projecting unit to keep on the first direction and continue projecting the input interface to the fixed area, the method further comprises: controlling the projecting unit to project the input interface to an update area along the second direction when duration of the projection of the input interface to the fixed area reaches a preset value, the update area being different from the fixed area.

According to the sixth aspect of the present disclosure, an electronic device comprising a projecting unit and a sensing unit is provided. The electronic device comprises:

an obtaining unit configured to obtain a trigger operation information when an input interface is projected to a fixed area in a first direction by the projecting unit, the trigger operation information triggering a change of the direction of the projecting unit from the first direction to the second direction;

a determination unit configured to determine whether a current scenario information of the electronic device meets a preset condition by using the sensing unit;

a control unit configured to control the projecting unit to keep on the first direction and continue projecting the input interface to the fixed area when the current scenario information meets the preset condition.

Preferably, the determination unit is specifically configured to: obtain the current scenario image corresponding to the current scenario information by the sensing unit; determine whether there are M faces in the first direction and N faces in the second direction based on the current scenario image, M being a positive integer and N being an integer greater than or equal to 0; wherein it is determined that the current scenario information meets the preset condition if there are M faces in the first direction and N faces in the second direction.

Preferably, the determination unit is specifically configured to: obtain the current scenario image corresponding to the current scenario information by the sensing unit; determine whether a specific face is in the first direction based on the current scenario image; determine the current scenario information meets the preset condition when the specific face is in the first direction.

Preferably, the determination unit is specifically configured to: obtain the current scenario sound corresponding to the current scenario information by the sensing unit; determine whether there is sound information in the first direction; wherein it is determined that the current scenario information meets the preset condition when there is sound information in the first direction.

Preferably, the determination unit is specifically configured to: obtain the current scenario sound corresponding to the current scenario information by the sensing unit; determine whether there is specific sound information in the first direction; wherein it is determined that the current scenario information meets the preset condition when there is specific sound information in the first direction.

Preferably, the control unit is further configured to: control the projecting unit to project the input device interface to an update area along the second direction when the current scenario information does not meet the preset condition, the update area being different from the fixed area.

Preferably, the control unit is further configured to: control the projecting unit to project the input interface to an update area along the second direction when duration of the projection of the input interface to the fixed area reaches a preset value, the update area being different from the fixed area.

In the embodiments of the present invention according to the fifth and sixth aspect, if the current scenario information of the electronic device meets the preset condition, the projecting unit is controlled to continue projecting in the original direction. The projecting direction will remain unchanged regardless of the change of direction of the projecting unit. For example, the electronic device projects content to an area and user A views the projected content. User A wants User B who is standing beside him to view the display screen. Then, user A turns the display screen to user B. If a projecting unit is located on the display screen, then it is obvious that the direction of the projecting unit changes accordingly. According to the method of the embodiments of the present invention, if the electronic device determines that the current scenario information meets the preset condition, the projecting direction will not change. In other words, the projecting unit would continue projecting in the original direction so that user A may continue viewing the projected content and operate according to the projected content. Since user A is facing to the projected content, error rate of operations of user A could be reduced and so could be the error rate of responses of the electronic device. In the meanwhile, user B can view the display screen directly. In another word, the solution of the embodiments of the present invention meets a requirement of users in various directions to view and use the electronic device. It improves the practicality and intelligence of the electronic device and meets the users' requirements.

Additionally, the embodiments of the present invention according to the various aspects described above can be combined in various ways to achieve various combined functions without departing the scope of the present invention. For instance, after or during the method according to the first aspect of the present invention is performed, the method according to the second aspect of the present invention can be performed to further facilitate the users' operations on the electronic device based on position relations of the operating bodies and the operation plane after the input interface such as mouse, keyboard, etc. is determined. For another instance, after or during the method according to the third aspect of the present invention is performed, the method according to the first or second aspect of the present invention can be performed to provide user A with convenient and accurate input methods while the screen content of the electronic device is shown to user B. The combination of the embodiments of the present invention are not limited to those described above, but can be performed in any way envisaged by those skilled in the art within the scope of the present invention.

### BRIEF DESCRIPTION OF THE DRAWINGS

The above and other objects, features and advantages of the present invention will be more obvious from the description of the preferred embodiments of the present invention with reference to the drawings, in which:

FIG. 1A is a main flow chart of an information processing method according to an embodiment of the present invention;

FIG. 1B is a diagram of an application scenario according to an embodiment of the present invention;

FIG. 2 is a main block diagram of the structure of an electronic device according to an embodiment of the present invention.

FIG. 3 is a main flow chart of an information processing method according to another embodiment of the present invention;

FIG. 4 is a main block diagram of the structure of an electronic device according to another embodiment of the present invention.

FIG. 5A is a main flow chart of an information processing method according to yet another embodiment of the present invention;

FIG. 5B is a diagram of an application scenario according to yet another embodiment of the present invention;

FIG. 5C is a diagram of an application scenario corresponding to FIG. 5B according to yet another embodiment of the present invention; and

FIG. 6 is a main block diagram of the structure of an electronic device according to yet another embodiment of the present invention.

### DETAILED DESCRIPTION OF THE EMBODIMENTS

An information processing method according to some embodiments of the present invention can be applied in an electronic device. The electronic device comprises a sensing unit configured to detect posture change of operating bodies in the sensing space which includes a first plane. The electronic device can operate in multiple working modes including a first working mode. The method comprises: detecting the number of the operating bodies in the sensing space by using the sensing unit to obtain a first detection result; detecting whether the operating bodies are located on the first plane by using the sensing unit to obtain a second detection result; and controlling the electronic device to work in the first working mode when the first detection result meets a first preset condition and/or the second detection result meets a second preset condition.

In the embodiments of the present invention, an electronic device detects the first detection result and the second detection result by the sensing unit; when the first detection result meets a first preset condition and/or the second detection result meets a second preset condition, the electronic device is controlled to work in the first working mode. That is, the electronic device may automatically adjust the manner in which the electronic device is controlled based on the detected results, such that the control manners of the electronic device complies with the user's current condition and no manual adjustments is required. The adaptive adjustment of the electronic device simplifies the operation process, improves the intelligence thereof, and brings the convenience to the users.

In order to further explain the objects, solutions and advantages of the embodiments of the present invention, the solutions of the embodiments of the present invention will be clearly and thoroughly described in connection with figures in the embodiments of the present invention. Obviously, the described embodiments are some, not all, of embodiments of the present invention. Other embodiments obtained by those ordinary skilled in the art without any inventive effort based on the embodiments of the present invention will fall into the scope of the present invention.

In the embodiments of the present invention, the electronic device could be various electronic devices such as PCs (personal computers), PADs (tablet computers), mobile phones, smart TVs, etc., and the present invention is not limited thereto.

Additionally, the term “and/or” used herein merely denotes a relationship between objects including three types of relationships, e.g. A and/or B may represent only A, both A and B, and only B. Additionally, the character “/” used herein generally represents a relationship of “or” between objects.

Preferred implementations of the present invention are illustrated in detail below in connection with figures.

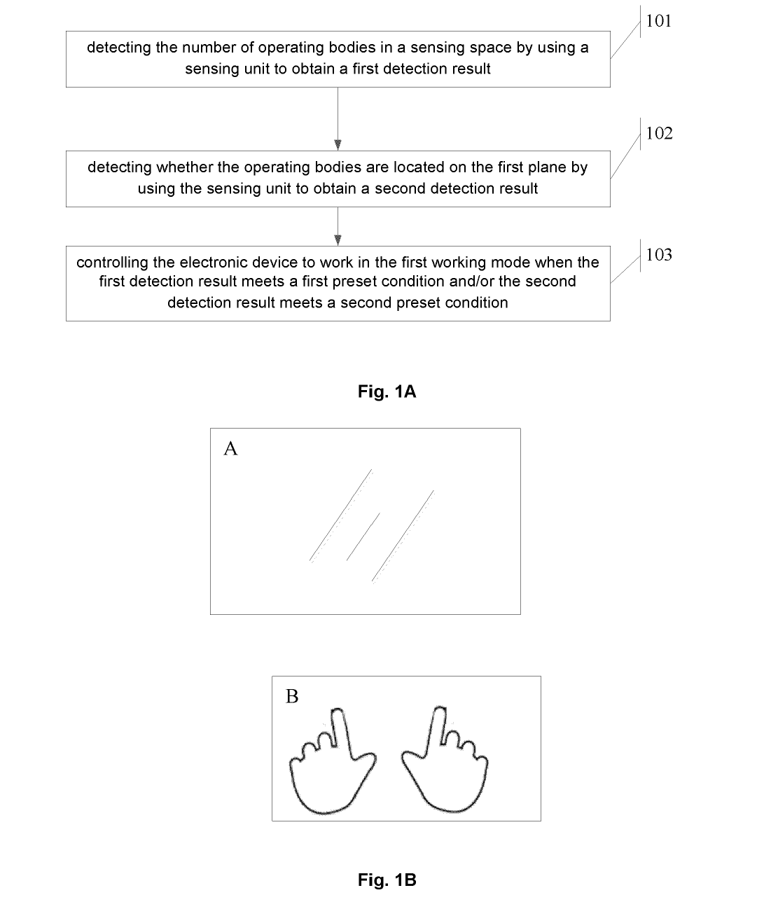

Referring to FIG. 1A, an information processing method in an electronic device according to an embodiment of the present invention is provided. The electronic device comprises a sensing unit, configured to detect posture change of operating bodies in a sensing space which includes a first plane. The electronic device may have multiple working modes including a first working mode. The main flow of the method is described as follows:

Step 101: the number of operating bodies in the sensing space is detected by using the sensing unit to obtain a first detection result.

In the embodiments of the present invention, the sensing unit may be an image capturing unit, a Leap Motion® controller (Somatosensory controller), or another type of sensing unit.

Images corresponding to the sensing space may be obtained by the sensing unit. The number of the images may be one or more. Preferably, the obtained images are required to cover the entire sensing space.

The sensing unit may detect whether there are operating bodies in the sensing space based on the obtained images. If it is determined that there is no operating body in the sensing space, the electronic device does not need to perform subsequent operations.

Preferably, the sensing unit may detect the sensing space in real-time, at certain time, or periodically, to detect whether there are operating bodies in the sensing space. As a result, if it is determined that there are operating bodies in the sensing space, the sensing unit may determine how many operating bodies are there in the sensing space, that is, the number of the operating bodies.

In the embodiments of the present invention, the operating bodies may be hands of users or other operating bodies.

After detection of the sensing unit, a first detection result may be obtained. There may be several cases for the first detection result. For example, one of them may be that the first detection result indicates that there is no operating body in the sensing space. For example, one of them may be that the first detection result indicates that there is one and only one operating body in the sensing space. For example, one of them may be that the first detection result indicates that there are two or more operating bodies in the sensing space.

Step 102: whether the operating bodies are located on the first plane is detected by using the sensing unit to obtain a second detection result.

In the embodiments of the present invention, the first plane may be one plane within the sensing space. Preferably, the first plane may be a plane in which the bottom of the electronic device is located. For example, if the electronic device is located on the surface of a desktop, the plane in which the bottom of the electronic device is located is the surface of the desktop. Since the sensing unit is located in the electronic device and the desktop surface is included in the sensing space, the desktop surface could be the first plane.

If the first detection result indicates that there is an operating body in the sensing space, the sensing unit may then determine whether the operating body is located on the first plane. For example, if the operating bodies are user's hands and the first plane is the desktop surface, the sensing unit may detect whether the operating bodies are located on the first plane, that is, whether the user's hands are located on the desktop surface.

One possible way for detecting whether the operating bodies are located on the first plane may be that: for one operating body, whether the distance between the operating body and one plane below the operating body which is the closest plane to the operating body is less than a preset distance may be detected. If it is determined that the distance between the operating body and the plane is less than the preset distance, the sensing unit may then detect whether the plane is the first plane. If it is determined that the plane is the first plane, the operating body may be determined to be located on the first plane.

Step 103: when the first detection result meets a first preset condition and/or the second detection result meets a second preset condition, the electronic device is controlled to work in the first working mode.

Specifically, Step 103 could be that: determining whether the first detection result meets the first preset condition and/or whether the second detection result meets the second preset condition; when it is determined that the first detection result meets the first preset condition and/or the second detection result meets the second preset condition, controlling the electronic device to work in the first working mode.

Optionally, in the embodiments of the present invention, when it is determined that the first detection result meets the first preset condition and/or the second detection result meets the second preset condition, controlling the electronic device to work in the first working mode may comprise: when the first detection result indicates that the number of the operating bodies is greater than or equal to 1, determining the first detection result meets the first preset condition; when the second detection result indicates that none of the operating bodies is located on the first plane, determining the second detection result meets the second preset condition; controlling the electronic device to work in the space-gesture control mode.

In this case, it is required that the first detection result meets the first preset condition, and the second detection result meets the second preset condition.

For example, when the operating bodies are user's hands, if the first detection result indicates that the number of the operating bodies is not less than 1, and the detection result indicates that all the operating bodies are not located on the first plane, it may be determined that the user's hands are hanging in the air which shows that the user may want to operate the electronic device by gestures. When the user wants to operate the electronic device by gestures, the number of hanging hands may be one or two. As a result, as long as the number of the operating bodies is not less than 1, the first preset condition can be met. At this time, it is determined that the user's hands are hanging in the air. Thus, the electronic device may determine that it is required to work in the space-gesture control mode in which the user may directly operate the electronic device by gestures.

Preferably, in the embodiments of the present invention, the controlling of the electronic device to work in the space-gesture control mode may comprise: controlling the electronic device to turn-on the space-gesture detection unit therein.

The electronic device may comprise a space-gesture detection unit. When the electronic device is not in the space-gesture control mode, the space-gesture detection unit may be turned-off in order to save power and avoid error operations by the users. When the electronic device is going to transition to the space-gesture control mode from other working modes, the electronic device may turn-on the space-gesture detection unit. The space-gesture detection unit may detect the user's gestures, and then respond to them based on the operation information detected by the space-gesture detection unit.

Optionally, in the embodiments of the present invention, the controlling of the electronic device to work in the first working mode when it is determined that the first detection result meets the first preset condition and/or the second detection result meets the second preset condition may comprise: when the first detection result indicates that the number of the operating bodies is equal to 1, determining the first detection result meets the first preset condition; when the second detection result indicates that the operating body is located on the first plane, determining the second detection result meets the second preset condition; controlling the electronic device to work in the gesture-simulate-mouse control mode.

In this case, it is required that the first detection result meets the first preset condition, and the second detection result meets the second preset condition.

For example, when the operating bodies are user's hands, if the first detection result indicates that the number of the operating bodies is 1, and the detection result indicates that the operating object is located on the first plane, it may be determined that one of the user's hands is put on the first plane. For example, when the first plane is the desktop surface on which the electronic device is placed, it indicates that the user may want to operate the electronic device by one hand (one way is to operate by a mouse). When the user is operating the electronic device with a mouse, one hand is used. Thus, the first preset condition is met as long as the number of the operating bodies is 1. At this time, it is determined that there is only one hand in the sensing space and this hand is placed on the first plane. Thus, the electronic device may determine that it is required to work in the gesture-simulate-mouse control mode in which the user may operate a virtual mouse like a real mouse to operate the electronic device.

Preferably, in the embodiments of the present embodiments, the controlling of the electronic device to work in the gesture-simulate-mouse control mode may comprise: controlling the electronic device to turn-on the gesture-simulate-mouse detection unit therein.

The electronic device may comprise a gesture-simulate-mouse detection unit. When the electronic device is not in the gesture-simulate-mouse control mode, the gesture-simulate-mouse detection unit may be turned-off in order to save power and avoid error operations by the user. When the electronic device will work in the gesture-simulate-mouse control mode from other working modes, the electronic device may turn-on the gesture-simulate-mouse detection unit. The gesture-simulate-mouse detection unit may detect the user's input operations, and then respond to them based on the operation information detected by the gesture-simulate-mouse detection unit.

Preferably, the user may perform input operations at the place where his/her hand is placed. The electronic device may determine the virtual input interface corresponding to the virtual mouse based on the location where the user's hand is located. As a result, the user can perform input operations without moving his/her hands to another place and this brings convenience to the user.

Optionally, in the embodiments of the present invention, the controlling of the electronic device to work in the first working mode when it is determined that the first detection result meets the first preset condition and/or the second detection result meets the second preset condition may comprise: when the first detection result indicates that the number of the operating bodies is greater than or equal to 2, determining the first detection result meets the first preset condition; when the second detection result indicates that all the operating bodies are located on the first plane, determining the second detection result meets the second preset condition; controlling the electronic device to work in the gesture-simulate-keyboard control mode.

For example, FIG. 1B is a diagram of an application scenario according to an embodiment of the present invention. In FIG. 1B, the electronic device may be, for example, a PAD shown as A. As shown, both hands of the user are located on the first plane in front of PAD. The first plane may be a desktop surface, for example. The location where the both hands of user are located is a sensing area. The projecting unit project the input interface into the sensing area, shown as area B in FIG. 1B. Additionally, there is a certain angle between the plane in which the display unit of the PAD is located and the first plane.

In this case, it is required that the first detection result meets the first preset condition, and the second detection result meets the second preset condition.

For example, when the operating bodies are user's hands, if the first detection result indicates that the number of the operating bodies is not less than 2, and the detection result indicates that the operating bodies are all located on the first plane, it may be determined that at least two hands are put on the first plane. For example, when the first plane is the desktop surface on which the electronic device is placed, it indicates that the user may want to operate the electronic device by two hands (one way is to operate by a keyboard). When the user is operating the electronic device with a keyboard, both hands are used. Thus, the first preset condition is met as long as the number of the operating bodies is not less than 2. At this time, it is determined that at least two hands of the user are in the sensing space and at least two hands are placed on the first plane. Thus, the electronic device may determine that it needs to work in the gesture-simulate-keyboard control mode in which the user may operate a virtual keyboard as a real keyboard to operate the electronic device.

Preferably, in the embodiments of the present embodiments, the controlling of the electronic device to work in the gesture-simulate-keyboard control mode may comprise: controlling the electronic device to turn-on the gesture-simulate-keyboard detection unit therein.

The electronic device may comprise a gesture-simulate-keyboard detection unit. When the electronic device is not in the gesture-simulate-keyboard control mode, the gesture-simulate-keyboard detection unit may be turned-off in order to save power and avoid error operations by the user. When the electronic device is going to transition to the gesture-simulate-keyboard control mode from another working mode, the electronic device may turn-on the gesture-simulate-keyboard detection unit. The gesture-simulate-keyboard detection unit may detect the user's input operations, and then respond to them based on the operation information detected by the gesture-simulate-keyboard detection unit.

Preferably, the user may perform input operations at the place where his/her hands are placed. The electronic device may determine the virtual input interface corresponding to the virtual keyboard based on the location where the user's hands are located. As a result, the user can perform input operations without moving his/her hands to another place and this brings convenience.

Additionally, in the embodiments of the present invention, the electronic device may further comprise a projecting unit. After the electronic device is controlled to work in the first working mode, the method may further comprise: controlling the projecting unit to project a virtual input interface corresponding to the first working mode for the user to input.

Preferably, if the first working mode is the gesture-simulate-mouse control mode, the electronic device may control the projecting unit to project a virtual input interface corresponding to the gesture-simulate-mouse control mode. As a result, users may input from the virtual mouse input interface. Preferably, the electronic device may control the projecting unit to project the virtual mouse input interface onto the first plane. In this way, users may view the virtual mouse input interface and input from the virtual mouse input interface. This reduces the possibility of error operations greatly and improves the response accuracy of the electronic device.

Preferably, if the first working mode is the gesture-simulate-keyboard control mode, the electronic device may control the projecting unit to project a virtual input interface corresponding to the gesture-simulate-keyboard control mode. As a result, users may input from the virtual keyboard input interface. Preferably, the electronic device may control the projecting unit to project the virtual keyboard input interface onto the first plane. As a result, users may view the virtual keyboard input interface and input from the virtual keyboard input interface. This reduces possibility of error-operation greatly and improves response accuracy of the electronic device.

Preferably, in the embodiments of the present invention, the controlling of the projecting unit to project a virtual input interface corresponding to the first working mode may comprise: determining the depth-of-field of the operating bodies by the sensing unit; determining the projecting area based on the determined depth-of-field; controlling the projecting unit to project the virtual input interface into the projecting area.

For example, the sensing unit may be a Leap Motion controller. The sensing unit may determine the depth-of-field of the operating bodies, that is, determine the specific locations of the operating bodies on the first plane. The electronic device may determine the projecting area based on the depth-of-field of the operating bodies. Preferably, when the projecting area overlaps the location of the operating bodies, the electronic device may control the projecting unit to project the virtual input interface into the projecting area. In this case, the location where user's hands are located is the projecting area, and user may perform input operations on the virtual input interface without moving his/her hands. This brings user with convenience and improves intelligence of the electronic device. Users can view the virtual input interface which is straightforward. This reduces possibility of error-operation and improves response accuracy of the electronic device.

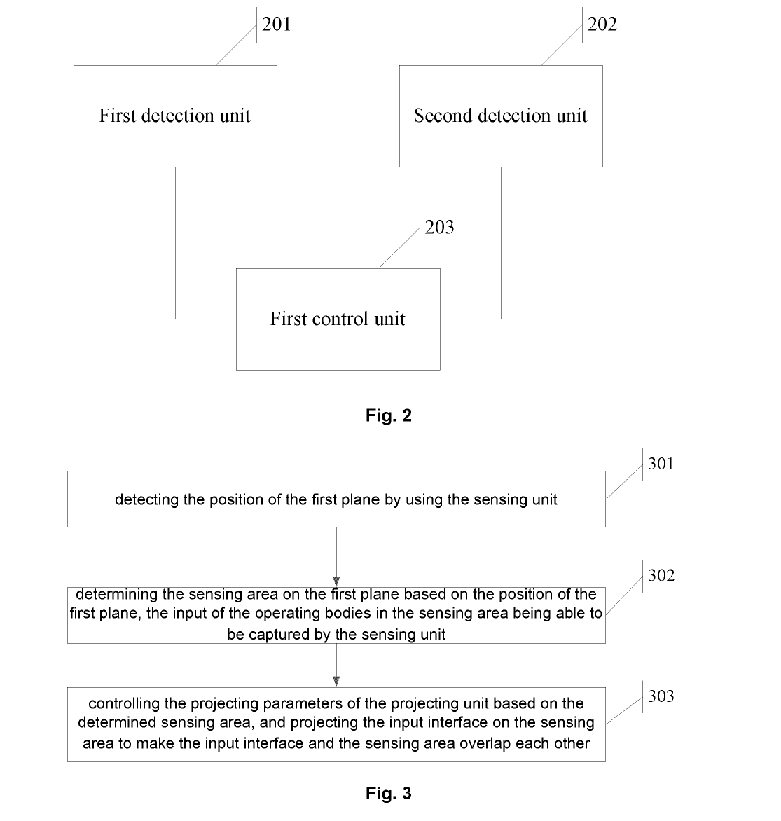

Referring to FIG. 2, based on the same inventive concept, an electronic device according to some embodiments of the present invention is provided. The electronic device comprises a sensing unit configured to detect posture change of operating bodies in the sensing space which includes a first plane. The electronic device can operate in multiple working modes including a first working mode. The electronic device further comprises a first detecting unit 201, a second detecting unit 202 and a first control unit 203.

a first detecting unit 201 may be configured to detect the number of the operating bodies in the sensing space by a sensing unit to obtain a first detection result.

a second detecting unit 202 may be configured to detect whether the operating bodies are located on the first plane by the sensing unit to obtain a second detection result.

a first control unit 203 may be configured to, when the first detection result meets a first preset condition and/or the second detection result meets a second preset condition, control the electronic device to work in the first working mode.

Preferably, in an embodiment of the present invention, the first control unit 203 may be specifically configured to: when the first detection result indicates that the number of the operating bodies is greater than or equal to 1, determine the first detection result meets the first preset condition; when the second detection result indicates that none of the operating bodies is located on the first plane, determine the second detection result meets the second preset condition; control the electronic device to work in the space-gesture control mode.

Preferably, in the embodiments of the present invention, the first control unit 203 configured to control the electronic device to work in the space-gesture control mode may specifically configured to: control the electronic device to turn-on the space-gesture detection unit therein.

Preferably, in the embodiments of the present invention, the first control unit 203 may be configured to: when the first detection result indicates that the number of the operating bodies is equal to 1, determine the first detection result meets the first preset condition; when the second detection result indicates that the operating body is located on the first plane, determine the second detection result meets the second preset condition; control the electronic device to work in the gesture-simulate-mouse control mode.

Preferably, in the embodiments of the present invention, the first control unit 203 configured to control the electronic device to work in the space-gesture control mode, may comprises: control the electronic device to turn-on the gesture-simulate-mouse detection unit therein.

Preferably, in the embodiments of the present invention, the first control unit 203 may be configured to: when the first detection result indicates that the number of the operating bodies is greater than or equal to 2, determine the first detection result meets the first preset condition; when the second detection result indicates that the operating bodies are located on the first plane, determine the second detection result meets the second preset condition; control the electronic device to work in the gesture-simulate-keyboard control mode.

Preferably, in the embodiments of the present invention, the first control unit 203 configured to control the electronic device to work in the space-gesture control mode may specifically configured to: control the electronic device to turn-on the gesture-simulate-keyboard control unit therein.

Preferably, in the embodiments of the present invention, the electronic device further comprises a projecting unit. The first control unit 203 is further configured to: control the projecting unit to project a virtual input interface corresponding to the first working mode for the user to input.

Preferably, in the embodiments of the present invention, the first control unit 203 is further configured to: determine the depth-of-field of the operating bodies by the sensing unit; determine the projecting area based on the determined depth-of-field; control the projecting unit to project the virtual input interface into the projecting area.

An information processing method according to the embodiments of the present invention can be applied in an electronic device. The electronic device comprises a sensing unit configured to detect posture change of operating bodies in the sensing space which comprises a first plane. The electronic device may have multiple working modes comprising a first working mode. The method comprises: detecting the number of the operating bodies in the sensing space by a sensing unit to obtain a first detection result; detecting whether the operating bodies are located on the first plane by the sensing unit to obtain a second detection result; controlling the electronic device to work in the first working mode when the first detection result meets a first preset condition and/or the second detection result meets a second preset condition.

In the embodiments of the present invention, the first detection result and the second detection result are detected and determined by the sensing unit; when the first detection result meets a first preset condition and/or the second detection result meets a second preset condition, the electronic device is controlled to work in the first working mode. That is, the electronic device may automatically adjust the control manners of the electronic device based on the detected result, such that the control manners of the electronic device complies with the user's current condition and no manual adjustments is required. The adaptive adjustment of the electronic device simplifies the operation process, improves the intelligence thereof, and brings convenience to the user.

Additionally, an information processing method in an electronic device comprising a sensing unit and a projecting unit according to some other embodiments of the present invention is provided. The sensing unit can detect posture change of operating bodies in a sensing space to perform input operations, the sensing space comprising a first plane. The projecting unit is configured to project an input interface. The method comprises following steps: detecting the position of the first plane by the sensing unit; determining the sensing area on the first plane based on the position of the first plane, the input of the operating bodies in the sensing area being able to be captured by the sensing unit; controlling the projecting parameters of the projecting unit based on the determined sensing area, and projecting the input interface on the sensing area to make the input interface and the sensing area overlap each other.

In the some other embodiments of the present invention, the sensing unit determines the sensing area, and then controls the projecting unit to project the input interface on the sensing area to make the input interface and the sensing area overlap each other. The operating bodies operate on the input interface, that is, on the sensing area. The sensing unit may directly respond to operation of the operating bodies. The sensing unit may be a Leap Motion controller which can precisely capture the operation of the operating bodies, and then both the capturing and responding are relatively more precise in view of a conventional solution where the user's operation is captured by a camera and then responded accordingly. This avoids the error responses to the user's operation, reduces the error rate of responses, and improves the user experience.

Referring to FIG. 3, an information processing method in an electronic device comprising a sensing unit and a projecting unit according to the some other embodiments of the present invention is provided. The sensing unit can detect posture change of operating bodies in the sensing space for an input operation the sensing space including a first plane. The projecting unit is configured to project an input interface. The main process of the method is as follows:

Step 301: the position of the first plane is detected by the sensing unit.

In the embodiments of the present invention, the sensing unit may be an image capturing unit, a Leap Motion controller (Somatosensory controller), or another type of sensing unit.

Images corresponding to the sensing space may be obtained by the sensing unit. The number of the images may be one or more. Preferably, the obtained images are required to cover the entire sensing space.

The detection unit may detect the position of the first plane based on the obtained image.

In the embodiments of the present invention, the first plane may be one plane within the sensing space. Preferably, the first plane may be a plane in which the bottom of the electronic device is located. For example, if the electronic device is located on the desktop surface, the plane in which the bottom of the electronic device is located is the desktop surface. Since the sensing unit is located in the electronic device and the desktop surface is included in the sensing space, the desktop surface could be the first plane.

Step 302: the sensing area on the first plane is determined based on the position of the first plane, the input of the operating bodies in the sensing area being able to be captured by the sensing unit.

The sensing unit detects the location of the first plane, determines the area, i.e. the sensing area, on the first unit controllable by the sensing unit, and determines the sensing area on the first plane based on the position of the first plane.

Since the sensing area is in the control area of the sensing unit, if operating bodies operate in the sensing area, the sensing unit can capture these operations.

Preferably, in the embodiments of the present invention, the determining of the sensing area on the first plane based on the position of the first plane comprises: capturing an image including a gesture information of the user by the sensing unit; when it is determined that the gesture information comprises at least one hand of the user and the first plane below the at least one hand, and that the distance between the at least one hand and the first plane is less than a preset distance, determining the sensing area on the first plane by the sensing unit.

The first plane is the closest plane to the at least one hand. If it is determined that the distance between the at least one hand and the first plane is less than a preset distance, the electronic device may consider, by default, that the at least one hand is located on the first plane, and determine the sensing area by the sensing unit.

That is, the electronic device determines the sensing area only when it determines that at least one hand is located on the first plane. Since the sensing area is used for the user to operate, if no hand is located on the first plane, then this indicates that user is not operating, and at this time the electronic device does not need to determine the sensing area.

In this way, the electronic device determines the sensing area only when it detects that the user needs to operate. This avoids the complexity of determining the sensing area at any time, reduces the load of the electronic device, and will not affect the normal operation by the user.

Preferably, when it is determined that the gesture information comprises at least one hand of the user and the first plane below the at least one hand, and the distance between the at least one hand and the first plane is less than a preset distance, determining the sensing area on the first plane based on the position of the first plane, comprises: determining the location of the at least one hand of the user as the sensing area by the sensing unit.

That is, the user may perform input operations at the place where his/her hand is placed. The electronic device may determine the sensing area based on the location where the user's hand is located. As a result, the user can perform input operations without moving his/her hands and this brings convenience.

Step 303: the projecting parameters of the projecting unit are controlled based on the determined sensing area, and the input interface is projected on the sensing area to make the input interface and the sensing area overlap each other.

After determining the sensing area, the sensing unit may determine, based on the sensing area, the projecting parameters which can be appropriately used for projecting the input area to the sensing area. After determining the projecting parameters, the sensing unit may transfer the projecting parameters to the projecting unit. The electronic device may control the projecting unit to project the input area to the sensing area appropriately based on the projecting parameters. As a result, the input interface and the sensing area overlap each other, and operations on the input interface by the user are equivalent to operations on the sensing area. The sensing unit may capture the user's operations and respond to them accordingly. In this case, the projecting unit is dedicated for projecting, and the sensing unit is dedicated for capturing and responding to user's operations. Comparing with capturing user's operations by a camera in the prior art, the capturing result obtained by the sensing unit capturing user's operations is more accurate. This brings the electronic device a more accurate responding result, and effectively reduces their error responding rate.

Preferably, in the embodiments of the present invention, the input interface may be an interface corresponding to the input device.

Preferably, in the embodiments of the present invention, the input interface may be a keyboard input interface and the input device may be a keyboard; or the input interface may be a mouse input interface and the input device may be a mouse; or the input interface may be a writing pad input interface and the input device may be a writing pad; or the input interface may be a touchpad input interface and the input device may be a touchpad; or the input device may be some other input device and the input interface is the input interface corresponding to the some other input device. The input devices may not be limited thereto.

Preferably, in the embodiments of the present invention, the input device may be real devices, e.g. build-in input devices of the electronic device, or input devices communicable with the electronic device. Alternatively, the input device may not actually exist, and the electronic device only stores the input interfaces corresponding to the input device, and projects them as required.

In the embodiments of the present invention, the sensing area and the input interface overlap each other as much as possible. For example, if the input interface is a keyboard input interface, the content included in the sensing area is also a keyboard input interface, and the size of the keyboard input interface is the same as that of the keyboard input interface included in the sensing area. After projecting the input interface to the sensing area by the projecting unit, the keyboard input interface and its counterpart included in the sensing area overlap each other exactly. For example, the location of each key in the keyboard input interface matches to the location of its counterpart in the keyboard input interface included in the sensing area. For example, when a user presses the key ‘K’ in the keyboard input interface, this is equivalent to that the key ‘K’ in the keyboard input interface included in the sensing area is pressed. Then, the sensing unit may capture the user's operations and respond based thereon.

In the embodiments of the present invention, the keyboard input interface included in the sensing area is invisible to users, and the sensing unit can control the sensing area. The reason of projecting the keyboard input interface by projecting unit is to make it visible to users. The users may perform the operations upon viewing the input interface. In this way, the operations become more straightforward and error operations are less likely to occur. Since the input interface and the sensing area overlap each other, the users operate on the visible input interface and it is the sensing unit to respond accordingly. This improves the accuracy of the responses.

Additionally, in the embodiments of the present invention, after the controlling of the projecting parameters of the projecting unit based on the determined sensing area, and projecting the input interface on the sensing area, the method further comprises: obtaining the operation information for the input interface by the sensing unit; responding to the operation information by the sensing unit and determining the corresponding position of the operation information on the input interface; performing operations corresponding to the determined locations.

For example, also shown in FIG. 1B which is also a diagram of an application scenario of the some other embodiments of the present invention. In FIG. 1B, the electronic device may be, for example, a PAD, denoted by A. As can be seen, both hands of the user are located on the first plane in front of the PAD. The first plane may be a desktop surface, for example. The location where the both hands of user are located is a sensing area. The projecting unit projects the input interface into the sensing area, shown as area B in FIG. 1B. Additionally, there is a certain angle between the plane in which the display unit of the PAD is located and the plane in which the first plane is located.

After projecting the input interface on the sensing area, the users may operate the input interface. Then, the sensing unit obtains the operation information corresponding to the operation. After obtaining the operation information, the sensing unit may respond to the operation information, and determine the specific location corresponding to the operation information on the input interface, that is, determine the specific location corresponding to the operation information in the sensing area. As a result, the electronic device may perform the operations corresponding to the determined location.

The sensing area includes several different sub-areas, each of which has a different function. Preferably, the function of each sub-area depends on the type of the input interface included in the sensing area. For example, if the input interface included in the sensing area is a keyboard input interface, each sub-area may correspond to a unique key, each key having a respective function.

Preferably, in the embodiments of the present invention, if the input interface is a keyboard input interface, the responding to the operation information by the sensing unit and the determining the corresponding position of the operation information on the input interface comprises: responding to the operation information by the sensing unit and determining the corresponding position of the operation information on the input interface; determining the virtual key corresponding to the location; the performing of the operations corresponding to the determined location comprises: performing the operations corresponding to the virtual key.

After projecting the input interface on the sensing area, the users may operate on the input interface. Then, the sensing unit obtains the operation information corresponding to the operation. If the input interface is the keyboard input interface, after obtaining the operation information, the sensing unit may respond to the operation information, determine the specific location corresponding to the operation information on the input interface, that is, determine the specific location corresponding to the operation information in the sensing area, and determine the operation information corresponds to which one or ones of the virtual keys in the sensing area. As a result, the electronic device may perform the operations corresponding to the determined virtual key(s). The number of the determined virtual key(s) may be one or more.

For example, if interface projected in the sensing area is the keyboard input interface, after projecting, the user may operate on the keyboard input interface, e.g., the user presses the virtual space key in the keyboard input interface. After operating, the sensing unit may obtain the operation information corresponding to the operation. After the operation information is obtained, the sensing unit may respond to the operation information, determine the specific location corresponding to the operation information on the input interface, that is, determine the specific location corresponding to the operation information in the sensing area, and determine the operation information corresponds to which one or ones of the virtual keys in the sensing area. In the embodiment, the sensing unit determines that the operation information corresponds to the virtual space key. As a result, the electronic device may perform the operations corresponding to the determined virtual space key.

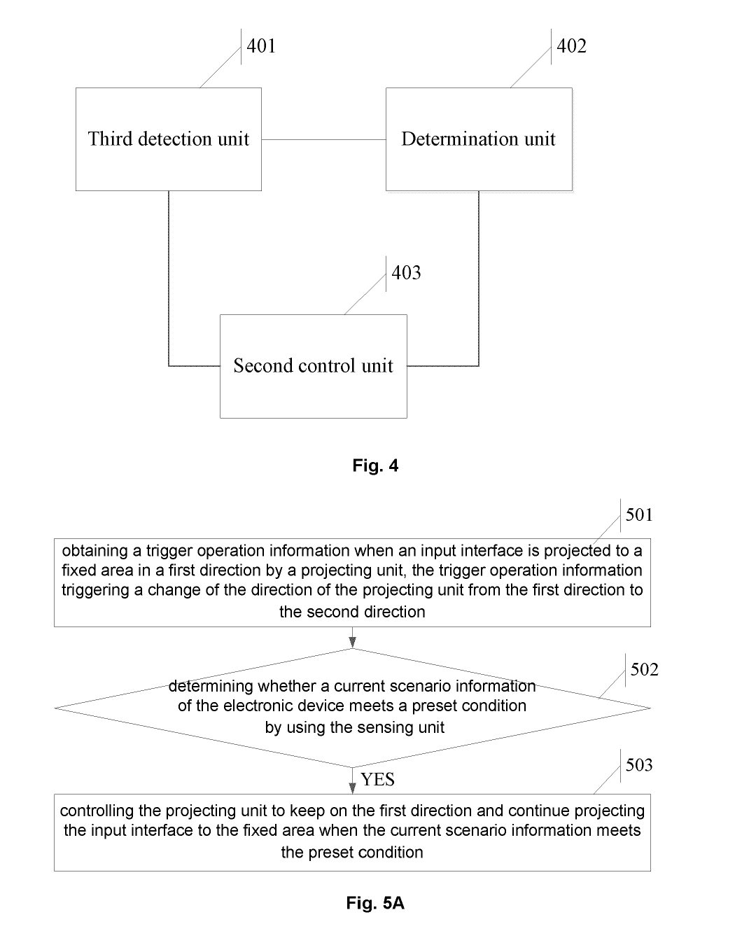

Referring to FIG. 4, based on the same inventive concept, an electronic device comprising a sensing unit and a projecting unit according to some other embodiments of the present invention is provided. The sensing unit can detect posture change of operating bodies in the sensing space which includes a first plane for an input operation. The projecting unit is configured to project an input interface. The electronic device further comprises: a third detection unit 401, a determination unit 402, and a second control unit 403.

The third detection unit 401 is configured to detect the position of the first plane by the sensing unit.

The determination unit 402 is configured to determine the sensing area on the first plane based on the position of the first plane, the input of the operating bodies in the sensing area being able to be captured by the sensing unit.

The second control unit 403 is configured to control the projecting parameters of the projecting unit based on the determined sensing area, and project the input interface on the sensing area to make the input interface and the sensing area overlap each other.

Preferably, in the embodiments of the present invention, the input interface may be an interface corresponding to an input device.

Preferably, in the embodiments of the present invention, the input interface is a keyboard input interface and the input device is a keyboard; or the input interface is a mouse input interface and the input device is a mouse; or the input interface is a writing pad input interface and the input device is a writing pad; or the input interface is a touchpad input interface and the input device is a touchpad.

Preferably, in the embodiments of the present invention, the determination unit 402 is specifically configured to: capture an image including a gesture information by the sensing unit; when it is determined that the gesture information comprises at least one hand of the user and the first plane below the at least one hand, and that the distance between the at least one hand and the first plane is less than a preset distance, determine the sensing area on the first plane by the sensing unit.

Preferably, in the embodiments of the present invention, the determination unit 402 configured to determine the sensing area on the first plane by the sensing unit comprises: determine the location of the at least one hand of the user as the sensing area by the sensing unit.

Preferably, in the embodiments of the present invention, the electronic device further comprises an obtaining unit, a responding unit, and an execution unit;

The obtaining unit is configured to: obtain operation information of the input interface by the sensing unit.

The responding unit is configured to: respond to the operation information by the sensing unit and determine the corresponding position of the operation information on the input interface.

the execution unit is configured to perform operations corresponding to the determined position.

Preferably, the responding unit configured to respond to the operation information by the sensing unit and determine the corresponding position of the operation information on the input interface is further configured to: when the input interface is a keyboard input interface, respond to the operation information by the sensing unit and determine the corresponding position of the operation information on the input interface; determine the virtual key corresponding to the location; the execution unit is configured to: perform operations corresponding to the virtual key.

An information processing method according to in the embodiments of the present invention in an electronic device comprising a sensing unit and a projecting unit is provided. The sensing unit can detect posture change of operating bodies in the sensing space, which includes a first plane, to perform input operations. The projecting unit is configured to project an input interface. The method comprises following steps: detecting the position of the first plane by the sensing unit; determining the sensing area on the first plane based on the position of the first plane, the sensing unit capturing the input of the operating bodies in the sensing area; controlling the projecting parameters of the projecting unit based on the determined sensing area, and projecting the input interface on the sensing area to make the input interface and the sensing area overlap each other.

In the embodiments of the present invention, the sensing unit determines the sensing area, and the projecting unit is controlled to project the input interface on the sensing area to make the input interface and the sensing area overlap each other. The operating bodies operate on the input interface, that is, on the sensing area. The sensing unit may directly respond to operations of the operating bodies. The sensing unit may be a Leap Motion controller which can precisely capture the operation by the operating bodies, and then both the capturing and responding are relatively more precise comparing with a conventional solution where the user's operation is captured by a camera and responded accordingly. This avoids the error responses to the user's operation, reduces the error rate of responses, and brings the user a well experience.

Additionally, an information processing method in an electronic device comprising a projecting unit and a sensing unit according to yet some other embodiments of the present invention is provided. The method comprises: obtaining a trigger operation information when the projecting unit is projecting an input interface to a fixed area along a first direction, the trigger operation information triggering a change of the direction of the projecting unit from the first direction to the second direction; determining whether a current scenario information of the electronic device meets a preset condition by using the sensing unit; controlling the projecting unit to keep on the first direction and continue projecting the input interface to the fixed area when the current scenario information meets the preset condition.

In the yet some other embodiments of the present invention, if the current scenario information meets the preset condition, the projecting unit is controlled to continue projecting in the original direction. The projecting direction will remain unchanged regardless of the change of direction of the projecting unit. For example, the electronic device projects content to an area and user A views the content. User A wants User B, who is standing beside, to view the display screen. Then, user A turns the display screen to user B. If a projecting unit is located on the display screen, it is obvious that the direction of the projecting unit changes accordingly. According to the method of the embodiments of the present invention, if the electronic device determines that the current scenario information meets the preset condition, the projecting direction will remain unchanged. In another word, the projecting unit would continue projecting in the original direction so that user A may continue view the projected content and operate according to the content. Since user A is facing the projected content, error rate of operations from user A could be reduced and so could the error rate of responses from the electronic device. In the mean while, user B can view the display screen directly. In another word, the solution of the embodiments of the present invention meets a requirement that users located in various directions may view and use the electronic device simultaneously. It improves the practicality and intelligence of the electronic device and meets the user's requirements.

In order to further explain the object, solutions and advantages of the yet some other embodiments of the present invention, the solutions of the embodiments of the present invention will be clearly and thoroughly described in connection with figures in the embodiments of the present invention. Obviously, the described embodiments are some, but not all, of embodiments of the present invention. Other embodiments obtained by those ordinary skilled in the art without any inventive effort based on the embodiments of the present invention will fall into the scope of the present invention.

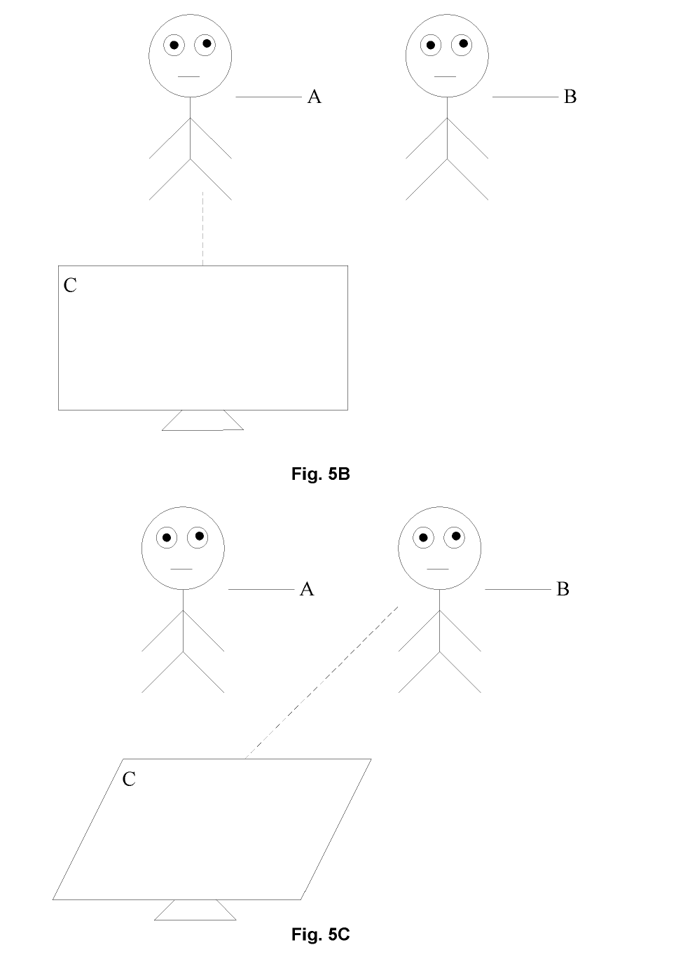

Referring to FIG. 5A, an information processing method according to yet some other embodiments of the present invention in an electronic device comprising a projecting unit and a sensing unit is provided. The main process of the method is as follows:

Step 501: a triggering operation information is obtained when the projecting unit is projecting an input interface to a fixed area along a first direction, the trigger operation information triggering a change of the direction of the projecting unit from the first direction to the second direction.

Firstly, the projecting unit is projecting the input interface.

In the embodiments of the present invention, the input interface may be an input interface corresponding to an input device. For example, the input interface may be a keyboard input interface corresponding to a keyboard, or the input interface may be a mouse input interface corresponding to a mouse, or the input interface may be a touchpad input interface corresponding to a touchpad, or the input interface may be a writing board input interface corresponding to a writing board, etc. Different input devices may correspond to different input interfaces. In the embodiments of the present invention, because the input devices are not limited to those mentioned above, the input interfaces are not limited to those mentioned above.

Additionally, the input device may be a real device, e.g. a build-in device of the electronic device, or an input device communicable with the electronic device. Alternatively, the input device may not actually exist, and the electronic device only stores the input interfaces corresponding to the input device, and projects them as required.

When the projecting unit projects the input interface, users may operate the electronic device. For example, the users may turn the electronic device to change the direction it is facing. The users' operation of turning the electronic device around may be a triggering operation, and the electronic device may obtain the triggering operation information corresponding to it.

For example, the electronic device initially projects the input interface to the fixed area along the first direction. Since user A is in the first direction and facing the input interface, he/she may see the input interface and operate the input interface.

User B is standing beside user A and in a second direction. As shown in FIG. 5B, A represents user A, B represents user B, C represents the electronic device, and the dash line represents the first direction. It can be seen that the electronic device is facing the first direction. Since user A wants user B to view the content on the display screen of the electronic device, user A turns the display screen to face user B. As shown in FIG. 5C, A represents user A, B represents user B, C represents the electronic device, and the dash line represents the second direction. It can be seen that the electronic device is facing the second direction. As a result, the display screen is turned from the first direction to the second direction. Generally, the projecting unit is located on the screen. Obviously, the direction of the projecting unit changes accordingly, from the first direction to the second direction. At this time, user B may face the content on the display screen. The users' operation of turning the electronic device around may be a triggering operation on the electronic device, and the electronic device may obtain the triggering operation information.

Step 502: whether current scenario information of the electronic device meets a preset condition is determined by using the sensing unit.

Preferably, in the embodiments of the present invention, the sensing unit may be of various types. For example, the sensing unit may be an image capturing unit, an audio capturing unit, or another type of sensing unit. The type of the sensing unit may not be limited thereto.

Preferably, if the sensing unit is the image capturing unit, one way of determining whether the current scenario information of the electronic device meets the preset condition may be: obtaining the current scenario image corresponding to the current scenario information by the image capturing unit; determining whether there are M faces in the first direction and N faces in the second direction based on the current scenario image, M being a positive integer and N being an integer greater than or equal to 0; wherein determining the current scenario information meets the preset condition if there are M faces in the first direction and N faces in the second direction.

That is, the current scenario images may be captured by the image capturing unit. The number of the current scenario images may be one or more. Since the images are captured by the image capturing unit, if there are a plurality of the current scenario images, the electronic device surely knows which images correspond to which directions respectively; and if there is only one current scenario image, the electronic device also knows the directions corresponding to the objects in the current scenario image.

M faces in the first direction indicate there are users in the first direction. Those users may continue viewing the input interface or operating on the input interface. At this time, the electronic device may determine that the current scenario information meets the preset condition, regardless of whether there are users in the second direction.

In this scenario, the electronic device may determine that the current scenario information meets the preset condition if there are users in the first direction after obtaining the triggering operation, regardless of whether there are users in the first direction before obtaining the triggering operation information. It can be seen that, if there are users in the first direction both before and after obtaining the triggering operation information, the users in the first direction before obtaining the triggering operation information may be the same as or different from the users after obtaining the triggering operation information. That is, the electronic device does not care who is always in the first direction. If the electronic device determines that there are users in the first direction based on the current scenario image, it may determine that the current scenario information meets the preset condition. As a result, as long as there are users viewing the input interface, the electronic device may determine that the current scenario information meets the preset condition. This guarantees that each user may use the electronic device in a normal way.

Preferably, if the sensing unit is the image capturing unit, one way of determining whether the current scenario information of the electronic device meets the preset condition may be: obtaining the current scenario image corresponding to the current scenario information by the image capturing unit; determining whether a specific face is in the first direction based on the current scenario image; determining the current scenario information meets the preset condition if the specific face is in the first direction.

That is, the current scenario images may be captured by the image capturing unit. The number of the current scenario images may be one or more. Since the images are captured by the image capturing unit, if there are a plurality of the current scenario images, the electronic device surely knows which images correspond to which directions respectively; and if there is only one current scenario image, the electronic device also knows the directions corresponding to the objects in the current scenario image.

A specific face in the first direction indicates a specific user is in the first direction. The specific user may continue viewing the input interface or operating on the input interface. At this time, the electronic device may determine that the current scenario information meets the preset condition, regardless of whether there are users in the second direction. The number of the specific faces may be one or more, that is, the number of the specific users may be one or more.

In this scenario, before obtaining the triggering operation information, the electronic device may first obtain images by the image capturing unit, and then determine whether there is a specific face in the first direction based on the obtained images. The electronic device may have stored the specific faces. After images are obtained, the electronic device may determine whether the faces included in the obtained image are the specific face. Alternatively, before obtaining the triggering operation information, the electronic device may first obtain images by the image capturing unit. The faces in the first direction included in the obtained image are the specific faces.

After obtaining the triggering operation information, the electronic device may continue obtaining the current scenario image by the image capturing unit. If there are faces in the first direction in the current image, the electronic device may determine whether they are specific faces. If the electronic device determines they are specific faces, the electronic device may determine that the current scenario information meets the preset condition.

Preferably, although there are faces in the current image, but the electronic device determines that the faces in the first direction in the current image are not specific faces, the electronic device may determine that the current scenario information does not meet the preset condition.

To sum up, there are following cases: if there are users in the first direction both before and after obtaining the triggering operation information, it is required that the users before obtaining the triggering operation information are the same as the users after obtaining the triggering operation information; if there are users in the first direction both before and after obtaining the triggering operation information, it is required that the users before obtaining the triggering operation information are the same as the users after obtaining the triggering operation information, the users should be the specific users; if there is no user in the first direction before obtaining the triggering operation information, but there are users in the first direction after obtaining the triggering operation information, the users after obtaining the triggering operation information is required to be the specific users.

In another word, the electronic device determines that the current scenario information meets the preset condition only after determining the users in the first direction are the specific users. As a result, as long as the specific users need to view the input interface, the electronic device may determine that the current scenario information meets the preset condition. This assures normal usage of the electronic device by each user.

In the mean while, considering following scenario: for example, the electronic device projects the input interface to the fixed area along the first direction. Since user A is in the first direction and facing the input interface, he/she may see the input interface and operate on the input interface. User B is standing opposite to user A, and facing to a second direction. Since user A wants user B to view the content on the display screen of the electronic device, user A turns the display screen around to face to user B. As a result, the direction of the display screen changes from the first direction to the second direction. After that, user A walks to and stands beside user B and views the screen display together with user B. User C walks to user A's original place. As a result, both user A and user B are in the second direction, and user C is in the first direction. However, user C may neither want to use the electronic device nor view the input interface. Thus, it is meaningless to keep the input interface in the first direction. On the contrary, this brings inconvenience because user A may still want to user the input interface. As a result, with the method in the embodiment of the present invention, since the users before and after obtaining the triggering operation information are different (obviously, the faces included in the current scenario images are not specific faces), the electronic device may determine that the current scenario information does not satisfy the preset condition. Consequently, user A may continue using the input interface. This will not influence user C since user C may not use the electronic device.

Preferably, if the sensing unit is the audio capturing unit, one way of determining whether the current scenario information of the electronic device meets the preset condition may be: obtaining the current scenario sound corresponding to the current scenario information by the audio capturing unit; determining whether there is sound information in the first direction; wherein, determining the current scenario information meets the preset condition if there is sound information in the first direction.

The sound in the current scenario (i.e., the current scenario sound) may be obtained by the audio capturing unit. The current scenario sound may be for multi-direction. Since the current scenario sound is captured by the audio capturing unit, the electronic device surely knows which piece of audio in the current scenario sound corresponds to which direction.

The electronic device may determine that whether there is sound information in the first direction. Sound information in the first direction indicates there are users in the first direction who may want to view the input interface, and the electronic device may determine that the current scenario information meets the preset condition.

In this scenario, the electronic device may determine that the current scenario information meets the preset condition if there is sound in the first direction after obtaining the triggering operation, regardless of whether there is sound in the first direction before obtaining the triggering operation information. That is, if there is sound in the first direction both before and after obtaining the triggering operation information, the users in the first direction before obtaining the triggering operation information may be the same as or different from the users after obtaining the triggering operation information. If there are users in the first direction both before and after obtaining the triggering operation information, the users in the first direction before obtaining the triggering operation information may be the same as or different from the users after obtaining the triggering operation information. That is, the electronic device does not care who is always in the first direction. If the electronic device determines that there are users in the first direction based on the current scenario image, it may determine that the current scenario information meets the preset condition. As a result, as long as there are users viewing the input interface, the electronic device may determine that the current scenario information meets the preset condition. This assures its normal usage by each user.

Preferably, if the sensing unit is the audio capturing unit, one way of determining whether the current scenario information of the electronic device meets the preset condition may be: obtaining the current scenario sound corresponding to the current scenario information by the audio capturing unit; determining whether there is specific sound information in the first direction; wherein, determining the current scenario information meets the preset condition if there is specific sound information in the first direction.

Since the current scenario sound is captured by the audio capturing unit, the electronic device surely knows which piece of audio in the current scenario sound corresponds to which direction.

Specific sound information in the first direction indicates the specific users are in the first direction. Those users may continue viewing the input interface or operating on the input interface. At this time, the electronic device may determine that the current scenario information meets the preset condition, regardless of whether there is sound in the second direction. The number of the specific sound may be one or more, that is, the number of the specific users may be one or more.

In this scenario, before obtaining the triggering operation information, the electronic device may first obtain scenario sound by the sound capturing unit, and then determine whether there is specific sound in the first direction based on the obtained scenario sound. The electronic device may have stored the specific sound. After obtaining the scenario sound, the electronic device may determine whether the sound included in the obtained scenario sound is the specific sound. Alternatively, before obtaining the triggering operation information, the electronic device may first obtain the scenario sound by the audio capturing unit. The sound in the first direction included in the obtained scenario sound is the specific sound.

After obtaining the triggering operation information, the electronic device may continue obtaining the current scenario sound by the sound capturing unit. If there is sound in the first direction in the current scenario sound, the electronic device may determine whether it is specific sound. If the electronic device determines it is specific sound, the electronic device may determine that the current scenario information meets the preset condition.

Preferably, although there is sound in the current scenario sound, but the electronic device determines that the sound in the first direction in the current scenario sound is not specific sound, the electronic device may determine that the current scenario information does not satisfy the preset condition.

To sum up, there are following cases: if there are users in the first direction both before and after obtaining the triggering operation information, it is required that the users before obtaining the triggering operation information are the same as the users after obtaining the triggering operation information; if there are users in the first direction both before and after obtaining the triggering operation information, it is required that the users before obtaining the triggering operation information are the same as the users after obtaining the triggering operation information, the users should be the specific users; if there is no user in the first direction before obtaining the triggering operation information, but there are users in the first direction after obtaining the triggering operation information, the users after obtaining the triggering operation information is required to be the specific users.

In another word, the electronic device determines that the current scenario information meets the preset condition only after determining the users in the first direction are the specific users. As a result, as long as the specific users need to view the input interface, the electronic device may determine that the current scenario information meets the preset condition. This assures normal usage of the electronic device by each user.

In the mean while, considering following scenario: for example, the electronic device projects the input interface to the fixed area along the first direction. Since user A is in the first direction and facing the input interface, he/she may see the input interface and operate on the input interface. User B is standing opposite to user A, and facing to a second direction. Since user A wants user B to view the content on the display screen of the electronic device, user A turns the display screen around to face to user B. As a result, the direction of the display screen changes from the first direction to the second direction. After that, user A walks to and stands beside user B and views the screen display together with user B. User C walks to user A's original place. As a result, both user A and user B are in the second direction, and user C is in the first direction. However, user C may neither want to use the electronic device nor view the input interface. Thus, it is meaningless to keep the input interface in the first direction. On the contrary, this brings inconvenience because user A may still want to user the input interface. As a result, by using the method in the embodiment of the present invention, since the users before and after obtaining the triggering operation information are different (obviously, since the sound before and after obtaining the triggering operation information are different, the sound included in the current scenario sound is not specific sound), the electronic device may determine that the current scenario information does not satisfy the preset condition. Consequently, user A may continue using the input interface. This will not influence user C since user C may not use the electronic device.

Step 503: the projecting unit is controlled to keep on the first direction and continue projecting the input interface to the fixed area when the current scenario information meets the preset condition.

If the electronic device determines that the current scenario information meets the preset condition, the projecting unit may be controlled to stay on the first direction and continue projecting the input interface to the fixed area.

If the electronic device determines that the current scenario information meets the preset condition which indicates there are users in the first direction who wants to view the input interface, it continues projecting the input interface in the original direction to satisfy the requirement of these users. At this time, although the direction of the projecting unit changes from the first direction to the second direction, the projecting direction thereof remains in the first direction.

Furthermore, in an embodiment of the present invention, after controlling the projecting unit to keep on the first direction and continue projecting the input interface to the fixed area, the method comprises: controlling the projecting unit to project the input interface to an update area along the second direction when duration of the projection of the input interface to the fixed area reaches a preset value, the update area being different from the fixed area.

When the duration of the projection of the input interface to the fixed area reaches a preset value, the electronic device believes the users in the first direction finish using the input interface, and determines changing the projecting direction of the projecting unit to the direction which the projecting unit is facing to satisfy the needs of users in the second direction. At this time, since the direction of the projecting unit is the second direction, the electronic device projects the input interface to an area (called update area) in the second direction. Since the fixed area is in the first direction, and the update area is in the second direction which is different from the first direction, the fixed area is different from the update area.

Furthermore, in an embodiment of the present invention, after determining whether the current scenario information of the electronic device does not satisfy a preset condition, the method further comprises: controlling the projecting unit to project the input interface to an update area along the second direction when the current scenario information does not satisfy with the preset condition; the update area being different from the fixed area.

If the electronic device determines that the current scenario information does not satisfy the preset condition in Step 502, it may control the projecting unit to project the input interface to the update area along the second direction. When the current scenario information does not satisfy the preset condition, the electronic device determines no user or no authorized user in the first direction wants to view the input interface, and it may change the projecting direction of the projecting unit to the direction which the projecting unit is facing to satisfy the needs of users in the second direction.

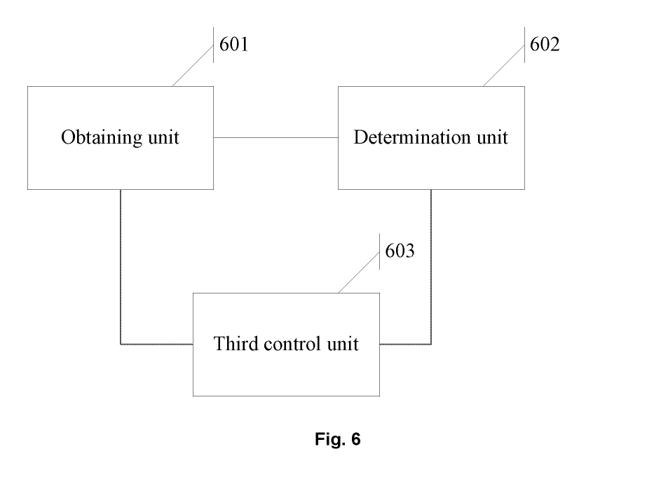

Referring to FIG. 6, an electronic device comprising a projecting unit and a sensing unit according to the embodiments of the present invention is provided. The electronic device may comprise an obtaining unit 601, a determination unit 602 and a third control unit 603.

The obtaining unit 601 is configured to obtain trigger operation information when the projecting unit is projecting an input interface to a fixed area along a first direction, the trigger operation information triggering a change of the direction of the projecting unit from the first direction to the second direction.

The determination unit 602 is configured to determine whether current scenario information of the electronic device meets a preset condition by the sensing unit.

The third control unit 603 is configured to: control the projecting unit to keep on the first direction and continue projecting the input interface to the fixed area when the current scenario information meets the preset condition.

Preferably, in the embodiments of the present invention, the determination unit 602 is configured to: obtain the current scenario image corresponding to the current scenario information by the sensing unit; determine whether there are M faces in the first direction and N faces in the second direction based on the current scenario image, M being a positive integer and N being an integer greater than or equal to 0; wherein it is determined that the current scenario information meets the preset condition if there are M faces in the first direction and N faces in the second direction.

Preferably, in the embodiments of the present invention, the determination unit 602 is configured to: obtain a current scenario image corresponding to the current scenario information by the sensing unit; determine whether a specific face is in the first direction based on the current scenario image; it is determined that the current scenario information meets the preset condition when the specific face is in the first direction.

Preferably, in the embodiments of the present invention, the determination unit 602 is configured to: obtain a current scenario sound corresponding to the current scenario information by the sensing unit; determine whether there is sound information in the first direction; wherein it is determined that the current scenario information meets the preset condition when there is sound information in the first direction.

Preferably, in the embodiments of the present invention, the determination unit 602 is configured to: obtain a current scenario sound corresponding to the current scenario information by the sensing unit; determine whether there is a specific sound information in the first direction; wherein it is determined the current scenario information meets the preset condition when there is the specific sound information in the first direction.

Preferably, in the embodiments of the present invention, the third control unit 603 is configured to: control the projecting unit to project the input device interface to an update area along the second direction when the current scenario information does not meet the preset condition, the update area being different from the fixed area.

Preferably, in the embodiments of the present invention, the control unit 603 is further configured to: control the projecting unit to project the input interface to an update area along the second direction when duration of the projection of the input interface to the fixed area reaches a preset value, the update area being different from the fixed area.

An information processing method in an electronic device comprising a projecting unit and a sensing unit according to the other embodiments of the present invention is provided. The method comprises: obtaining a trigger operation information when the projecting unit is projecting an input interface to a fixed area along a first direction, the trigger operation information triggering a change of the direction of the projecting unit from the first direction to the second direction; determining whether a current scenario information of the electronic device meets a preset condition by the sensing unit; controlling the projecting unit to keep on the first direction and continue projecting the input interface to the fixed area when the current scenario information meets the preset condition.

In other embodiments of the present invention, if the current scenario information meets the preset condition, the projecting unit is controlled to continue projecting in the original direction. The projecting direction will remain unchanged regardless of the change of direction of the projecting unit. For example, the electronic device projects content to an area and user A views the content. User A wants User B who is standing beside to view the display screen. Then, user A turns the display screen to user B. If a display unit is located on the display screen, the direction of the display unit changes accordingly. According to the method of the embodiments of the present invention, if the electronic device determines that the current scenario information meets the preset condition, the projecting direction will remain unchanged. In another word, the projecting unit would continue projecting in the original direction so that user A may continue viewing the projected content and operate according to the content. Since user A is facing the projected content, error operating rate of user A could be reduced and so could the error responding rate of the electronic device. In the mean while, user B can view the display screen directly. In another word, the solution of the embodiments of the present invention meets a requirement of view and usage of the electronic device by users in various directions. It improves the practicality and intelligence of the electronic device and meets the user's requirement.

In a few embodiments provided in present invention, it should be appreciated that the disclosed systems, apparatuses, and methods can be implemented in other ways. For example, the above depicted apparatus embodiment is only illustrative. For instance, the dividing of the modules or units is only a logic functional division. In practical implementations, other ways for dividing are possible, e.g. multiple units or components could be combined or integrated into another system, or a feature can be omitted or not executed. Another point is that the coupling between each other, or direct coupling, or communicative connection shown or discussed could be indirect coupling or communicative connection through some interfaces, apparatuses, or units, which could be electrical, mechanical, or other forms.

The units explained as discrete components may or may not be physically separated. Components shown as units may or may not be physical units, i.e. may be located in one place or distributed in multiple network units. Part or all of the units can be selected, according to actual needs, to achieve the object of approaches of present embodiment.

Additionally, various functional units in the embodiments of present invention can be integrated in one processing unit, or various units can individually, physically exist, or two or more units can be integrated into one unit. The integrated units discussed above can be implemented in the form of both hardware and software functional units.

When the integrated units are implemented in the form of software functional units and sold and utilized as self-contained products, they can be stored in one computer readable storage medium. Based on such understanding, the technical solutions of present invention substantially or parts which contribute to the prior art or all or parts of the technical solutions can be embodied in the form of software product. The computer software product which is stored in a storage medium includes several instructions which makes a computer device (may be a personal computer, a server, or a network device) or processor to execute all or part of the steps of the methods illustrated in various embodiments of present application. The storage medium discussed above comprises various medium which can store program codes, such as, flash disks, portable hard drives, Read-Only Memory (ROM), Random Access Memory (RAM), magnetic disc or optical disc etc.

Specifically, the computer program instructions corresponding to the information processing method in some embodiments of present application can be stored in storage medium such as optical disc, hard drive, or flash drive, etc. When the computer program instructions corresponding to the information processing method in the storage medium are read and executed by an electronic device, the method comprises:

detecting the number of the operating bodies in the sensing space by a sensing unit to obtain a first detection result;

detecting whether the operating bodies are located on the first plane by the sensing unit to obtain a second detection result; and

controlling the electronic device to work in the first working mode when the first detection result meets a first preset condition and/or the second detection result meets a second preset condition.

Optionally, when the computer instructions, which are stored in the storage medium and corresponding to the steps of controlling the electronic device to work in the first working mode when the first detection result meets a first preset condition and/or the second detection result meets a second preset condition, are executed, the method comprises:

when the first detection result indicates that the number of the operating bodies is greater than or equal to 1, determining the first detection result meets the first preset condition;

when the second detection result indicates that none of the operating bodies is located on the first plane, determining the second detection result meets the second preset condition;

controlling the electronic device to work in the space-gesture control mode.

Optionally, when the computer instructions, which are stored in the storage medium and corresponding to the step of controlling the electronic device to work in the space-gesture control mode, are executed, the method comprises:

controlling the electronic device to turn-on the space-gesture detection unit therein.

Optionally, when the computer instructions, which are stored in the storage medium and corresponding to the steps of controlling the electronic device to work in the first working mode when the first detection result meets a first preset condition and/or the second detection result meets a second preset condition, are executed, the method comprises:

when the first detection result indicates that the number of the operating bodies is equal to 1, determining the first detection result meets the first preset condition;

when the second detection result indicates that the operating body is located on the first plane, determining the second detection result meets the second preset condition;

controlling the electronic device to work in a gesture-simulate-mouse control mode.

Optionally, when the computer instructions, which are stored in the storage medium and corresponding to the step of controlling the electronic device to work in the gesture-simulate-mouse control mode, are executed, the method comprises:

controlling the electronic device to turn-on the gesture-simulate-mouse detection unit therein.

Optionally, when the computer instructions, which are stored in the storage medium and corresponding to the steps of controlling the electronic device to work in the first working mode when the first detection result meets a first preset condition and/or the second detection result meets a second preset condition, are executed, the method comprises:

when the first detection result indicates that the number of the operating bodies is greater than or equal to 2, determining the first detection result meets the first preset condition;

when the second detection result indicates that all the operating bodies are located on the first plane, determining the second detection result meets the second preset condition;

controlling the electronic device to work in a gesture-simulate-keyboard control mode.

Optionally, when the computer instructions, which are stored in the storage medium and corresponding to the step of controlling the electronic device to work in the gesture-simulate-keyboard control mode, are executed, the method comprises:

controlling the electronic device to turn-on the gesture-simulate-keyboard detection unit therein.

Optionally, when the computer instructions, which are stored in the storage medium and corresponding to the step of after controlling the electronic device to work in the first working mode, are executed, the method comprises: controlling the projecting unit to project a virtual input interface corresponding to the first working mode for the user to input.

Optionally, when the computer instructions, which are stored in the storage medium and corresponding to the step of controlling the projecting unit to project a virtual input interface corresponding to the first working mode, are executed, the method comprises:

determining the depth-of-field of the operating bodies by the sensing unit;

determining the projecting area based on the determined depth-of-field; and

controlling the projecting unit to project the virtual input interface into the projecting area.

Additionally, the computer program instructions corresponding to the information processing method in some other embodiments of present application can be stored in storage medium such as optical disc, hard drive or flash drive etc. When the computer program instructions corresponding to the information processing method in the storage medium are read and executed by an electronic device, the method comprises:

detecting the position of the first plane by the sensing unit;

determining the sensing area on the first plane based on the position of the first plane, the input of the operating bodies in the sensing area being able to be captured by the sensing unit; and

controlling the projecting parameters of the projecting unit based on the determined sensing area, and projecting the input interface on the sensing area to make the input interface and the sensing area overlap each other.

Optionally, the input interface is the interface corresponding to the input device.

Optionally, the input interface is a keyboard input interface and the input device is a keyboard; or the input interface is a mouse input interface and the input device is a mouse; or the input interface is a writing pad input interface and the input device is a writing pad; or the input interface is a touchpad input interface and the input device is a touchpad.

Optionally, when the computer instructions, which are stored in the storage medium and corresponding to the step of determining the sensing area on the first plane based on the position of the first plane, are executed, the method comprises:

capturing an image including gesture information of a user by the sensing unit; when it is determined that the gesture information comprises at least one hand of the user and the first plane below the at least one hand, and the distance between the at least one hand and the first plane is less than a preset distance, determining the sensing area on the first plane by the sensing unit.

Optionally, when the computer instructions, which are stored in the storage medium and corresponding to the step of determining the sensing area on the first plane by the sensing unit, are executed, the method may comprise:

determining the location of the at least one hand of the user as the sensing area by the sensing unit.

Optionally, when the computer instructions, which are stored in the storage medium and corresponding to the step of controlling the projecting parameters of the projecting unit based on the determined sensing area and projecting the input interface on the sensing area, are executed, the method further comprises:

obtaining operation information of the input interface by the sensing unit;

responding to the operation information by the sensing unit and determining the corresponding position of the operation information on the input interface; and

performing operations corresponding to the determined position.

Optionally, when the computer instructions, which are stored in the storage medium and corresponding to the step of responding to the operation information by the sensing unit and determining the corresponding position of the operation information on the input interface, are executed, the method comprises:

responding to the operation information by the sensing unit and determining the corresponding position of the operation information on the input interface; determining the virtual key corresponding to the location;

the performing of operations corresponding to the determined position comprises: performing operations corresponding to the virtual key.

Additionally, the computer program instructions corresponding to the information processing method in yet some other embodiments of present application can be stored in storage medium such as optical disc, hard drive or flash drive etc. When the computer program instructions corresponding to the information processing method in the storage medium are read and executed by an electronic device, the method comprises:

obtaining trigger operation information when an input interface is projected to a fixed area along a first direction by a projecting unit, the trigger operation information triggering a change of the direction of the projecting unit from the first direction to the second direction.

determining whether current scenario information of the electronic device meets a preset condition by the sensing unit; and

controlling the projecting unit to remain in the first direction and continuing projecting the input interface to the fixed area when the current scenario information meets the preset condition.

Optionally, when the computer instructions, which are stored in the storage medium and corresponding to the step of determining whether current scenario information of the electronic device meets a preset condition by the sensing unit, are executed, the method comprises:

obtaining a current scenario image corresponding to the current scenario information by the sensing unit; and

determining whether there are M faces in the first direction and N faces in the second direction based on the current scenario image, M being a positive integer and N being an integer greater than or equal to 0,

wherein it is determined that the current scenario information meets the preset condition if there are M faces in the first direction and N faces in the second direction.

Optionally, when the computer instructions, which are stored in the storage medium and corresponding to the step of determining whether a current scenario information of the electronic device meets a preset condition by the sensing unit, are executed, the method may comprise:

obtaining a current scenario image corresponding to the current scenario information by the sensing unit;

determining whether a specific face is in the first direction based on the current scenario image; and

determining the current scenario information meets the preset condition when the specific face is in the first direction.

Optionally, when the computer instructions, which are stored in the storage medium and corresponding to the step of determining whether a current scenario information of the electronic device meets a preset condition by the sensing unit, are executed, the method comprises:

obtaining a current scenario sound corresponding to the current scenario information by the sensing unit;

determining whether there is sound information in the first direction; and

wherein it is determined that the current scenario information meets the preset condition when there is sound information in the first direction.

Optionally, when the computer instructions, which are stored in the storage medium and corresponding to the step of determining whether a current scenario information of the electronic device meets a preset condition by the sensing unit, are executed, the method comprises:

obtaining a current scenario sound corresponding to the current scenario information by the sensing unit;

determining whether there is specific sound information in the first direction; and

wherein it is determined that the current scenario information meets the preset condition when there is specific sound information in the first direction.

Optionally, after the computer instructions, which are stored in the storage medium and corresponding to the step of determining whether the current scenario information of the electronic device meets a preset condition, are executed, the method further comprises: controlling the projecting unit to project the input device interface to an update area along the second direction when the current scenario information does not meet the preset condition, the update area being different from the fixed area.

Optionally, after the computer instructions, which are stored in the storage medium and corresponding to the step of controlling the projecting unit to keep on the first direction and continuing projecting the input interface to the fixed area, are executed, the method further comprises: controlling the projecting unit to project the input interface to an update area along the second direction when duration of the projection of the input interface to the fixed area reaches a preset value, the update area being different from the fixed area.

As described above, the above embodiments are used to introduce the solution of the present application in detail. The illustration of the embodiments is intended for facilitating understanding of the methods and main concept of the present invention, but should not be construed as limitations. Variations or alternations easily contemplated by those skilled in the art within the scope of the present invention are all covered in the scope of the present invention.

Additionally, as mentioned above, the embodiments of the present invention can be combined in a broad range of ways to implement various combined functions without departing the scope of the present invention. For instance, after or during implementing the method according to the first aspect of the present invention, the method according to the second aspect of the present invention can be implemented to further facilitate the operation of the electronic device by the user based on related position of the operating bodies and the operation plane after determining usage of the input interface such as mouse, keyboard, etc. For another instance, after or during implementing the method according to the third aspect of the present invention, the method according to the first or second aspect of the present invention can be implemented to provide user A with convenient and accurate input methods when exhibiting the display screen of the electronic device to user B. The ways of combination of the embodiments of the present invention are not limited to those described above, but can be performed in any way expected by those skilled in the art within the scope of the present invention.

What is claimed is:

1. An information processing method in an electronic device comprising a sensing unit configured to detect posture change of operating bodies in a sensing space which comprises a first plane, the electronic device having multiple working modes comprising a first working mode, the method comprising:
detecting the number of the operating bodies in the sensing space by using a sensing unit to obtain a first detection result;
detecting whether the operating bodies are located on the first plane by using the sensing unit to obtain a second detection result; and
controlling the electronic device to work in the first working mode when the first detection result meets a first preset condition and/or the second detection result meets a second preset condition.

2. The method according to claim 1, wherein the controlling of the electronic device to work in the first working mode when the first detection result meets a first preset condition and/or the second detection result meets a second preset condition comprises:
determining the first detection result meets the first preset condition when the first detection result indicates that the number of the operating bodies is greater than or equal to 1;
determining the second detection result meets the second preset condition when the second detection result indicates that none of the operating bodies is located on the first plane; and
controlling the electronic device to work in the space-gesture control mode.

3. The method according to claim 2, wherein the controlling of the electronic device to work in the space-gesture control mode comprises: controlling the electronic device to turn-on the space-gesture detection unit therein.

4. The method according to claim 1, wherein the controlling of the electronic device to work in the first working mode when the first detection result meets a first preset condition and/or the second detection result meets a second preset condition comprises:
determining the first detection result meets the first preset condition when the first detection result indicates that the number of the operating bodies is equal to 1;
determining the second detection result meets the second preset condition when the second detection result indicates that the operating body is located on the first plane; and
controlling the electronic device to work in a gesture-simulate-mouse control mode.

5. The method according to claim 4, wherein the controlling of the electronic device to work in the gesture-simulate-mouse control mode comprises: controlling the electronic device to turn-on the gesture-simulate-mouse detection unit therein.

6. The method according to claim 1, wherein the controlling of the electronic device to work in the first working mode when the first detection result meets a first preset condition and/or the second detection result meets a second preset condition comprises:
determining the first detection result meets the first preset condition when the first detection result indicates that the number of the operating bodies is greater than or equal to 2;
determining the second detection result meets the second preset condition when the second detection result indicates that all the operating bodies are located on the first plane; and
controlling the electronic device to work in a gesture-simulate-keyboard control mode.

7. The method according to claim 6, wherein the controlling of the electronic device to work in the gesture-simulate-keyboard control mode comprises:
controlling the electronic device to turn-on the gesture-simulate-keyboard control unit therein.

8. The method according to claim 1, wherein the electronic device further comprises a projecting unit, and wherein after the controlling of the electronic device to work in the first working mode, the method further comprises: controlling the projecting unit to project a virtual input interface corresponding to the first working mode, for a user to perform input operations via the virtual input interface.

9. The method according to claim 8, wherein the controlling of the projecting unit to project a virtual input interface corresponding to the first working mode comprises:
determining the depth-of-field of the operating bodies by the sensing unit;
determining the projecting area based on the determined depth-of-field; and
controlling the projecting unit to project the virtual input interface into the projecting area.

10. The method according to claim 1, wherein the electronic device further comprises a projecting unit for projecting an input interface, and wherein the method further comprises steps of:
detecting the position of the first plane by using the sensing unit;
determining the sensing area on the first plane based on the position of the first plane, the input of the operating bodies in the sensing area being able to be captured by the sensing unit; and
controlling the projecting parameters of the projecting unit based on the determined sensing area, and projecting the input interface on the sensing area to make the input interface and the sensing area overlap each other.

11. The method according to claim 10, wherein the determining of the sensing area on the first plane based on the position of the first plane comprises: capturing an image comprising gesture information of a user by the sensing unit; determining the sensing area on the first plane by the sensing unit when it is determined that the gesture information comprises at least one hand of the user and the first plane below the at least one hand and that the distance between the at least one hand and the first plane is less than a preset distance.

12. The method according to claim 10, wherein after the controlling of the projecting parameters of the projecting unit based on the determined sensing area and the projecting of the input interface on the sensing area, the method further comprises:
obtaining operation information with respect to the input interface by the sensing unit;
responding to the operation information by the sensing unit and determining the corresponding position of the operation information on the input interface; and
performing an operation corresponding to the determined position.

13. The method according to claim 12, wherein the responding to the operation information by the sensing unit and the determining of the corresponding position of the operation information on the input interface when the input interface is a keyboard input interface comprises: responding to the operation information by the sensing unit and determining the corresponding position of the operation information on the input interface; and determining the virtual key corresponding to the location; and
where the performing of an operation corresponding to the determined position comprises: performing an operation corresponding to the virtual key.

14. The method according to claim 1, wherein the electronic device further comprises a projecting unit for projecting an input interface, and wherein the method further comprises:
obtaining a trigger operation information when an input interface is projected to a fixed area in a first direction by the projecting unit, the trigger operation information triggering a change of the direction of the projecting unit from the first direction to the second direction;
determining whether a current scenario information of the electronic device meets a preset condition by using the sensing unit; and
controlling the projecting unit to keep on the first direction and continue projecting the input interface to the fixed area when the current scenario information meets the preset condition.

15. The method according to claim 14, wherein the determining of whether current scenario information of the electronic device meets a preset condition by using the sensing unit comprises:
obtaining a current scenario image corresponding to the current scenario information by the sensing unit; and
determining whether there are M faces in the first direction and N faces in the second direction based on the current scenario image, M being a positive integer and N being an integer greater than or equal to 0,
wherein it is determined that the current scenario information meets the preset condition if there are M faces in the first direction and N faces in the second direction.

16. The method according to claim 14, wherein the determining of whether current scenario information of the electronic device meets a preset condition by using the sensing unit comprises:
obtaining a current scenario image corresponding to the current scenario information by the sensing unit;
determining whether a specific face is in the first direction based on the current scenario image; and
determining that the current scenario information meets the preset condition when the specific face is in the first direction.

17. The method according to claim 14, wherein the determining of whether current scenario information of the electronic device meets a preset condition by using the sensing unit comprises:
obtaining a current scenario sound corresponding to the current scenario information by the sensing unit;
determining whether there is sound information in the first direction;
wherein it is determined that the current scenario information meets the preset condition when there is sound information in the first direction.

18. An electronic device comprising a sensing unit configured to detect posture change of operating bodies in the sensing space which comprises a first plane, the electronic device having multiple working modes comprising a first working mode, the electronic device further comprising:
a first detecting unit configured to detect the number of the operating bodies in the sensing space by using a sensing unit to obtain a first detection result;
a second detecting unit configured to detect whether the operating bodies are located on the first plane by using the sensing unit to obtain a second detection result; and
a first control unit configured to control the electronic device to work in the first working mode when the first detection result meets a first preset condition and/or the second detection result meets a second preset condition.

19. The electronic device according to claim 18, wherein the electronic device further comprises a projecting unit for projecting an input interface, and wherein the electronic device further comprises:
a third detection unit configured to detect the position of the first plane by using the sensing unit;
a determination unit configured to determine the sensing area on the first plane based on the position of the first plane, the input of the operating bodies in the sensing area being able to be captured by the sensing unit; and
a second control unit configured to control the projecting parameters of the projecting unit based on the determined sensing area, and configured to project the input interface on the sensing area to make the input interface and the sensing area overlap each other.

20. The electronic device according to claim 18, wherein the electronic device further comprises a projecting unit for projecting a input interface, and wherein the electronic device further comprises:
an obtaining unit configured to obtain a trigger operation information when an input interface is projected to a fixed area in a first direction by the projecting unit, the trigger operation information triggering a change of the direction of the projecting unit from the first direction to the second direction;
a determination unit configured to determine whether a current scenario information of the electronic device meets a preset condition by using the sensing unit; and
a third control unit configured to control the projecting unit to keep on the first direction and continue projecting the input interface to the fixed area when the current scenario information meets the preset condition.
